(19) United States
(12) Patent Application Publication
(10) Pub. No.: US 2009/0193406 A1
(43) Pub. Date: Jul. 30, 2009

(54) Bulk Search Index Updates

(76) Inventor: James Charles Williams, Hawi, HI (US)

Correspondence Address: NORTH WEBER & BAUGH LLP, 2479 E. BAYSHORE ROAD, SUITE 707, PALO ALTO, CA, 94303, US

(21) Appl. No.: 12/022,073

(22) Filed: Jan. 29, 2008

(51) Int. Cl. G06F 9/44

(52) U.S. Cl. 717/168

(57) ABSTRACT

Embodiments of the present invention perform bulk updates of a search index for an information repository. In embodiments, a batched set of update requests is run and a set of documents to be updated based on the set of requests is identified. In embodiments, a bulk update method to use is selected based on an estimate of the cost of performing the bulk update. In embodiments, a bulk update method based on updating only the indexes of the documents to be updated may be used instead of a bulk update method that involves re-indexing the full set of documents in the repository.

### BACKGROUND

A. Technical Field

The present invention pertains generally to data management architectures, and relates more particularly to devices and methods for performing bulk search index updates.

B. Background of the Invention

The World Wide Web and other advances in computer science have resulted in a dramatic increase in the amount of published information. This abundance of information has led to the development of tools and applications that address the pressing requirements for accessing and managing information efficiently. One example of such an application is a search engine, an application designed to facilitate fast and efficient information retrieval.

Many types of applications, such as search engines, make use of a search index in order to perform information retrieval. A search index enables an application to search a large repository of items for specific content without having to scan every item in the repository. For example, a search index allows a search engine to search the email documents in a repository to find the documents containing specific content by executing queries or other types of requests that contain key words and/or phrases associated with the content.

Since a search index represents the information in a repository, the search index should be updated whenever the information in the repository changes. The cost (in terms of computing resources and time) of updating a search index may be very high, especially if the information repository is large and/or is changing often. The consumption of computing resources during an update may reduce the performance of an application and introduce significant delays in the operation of the application.

### SUMMARY OF THE INVENTION

Embodiments of the present invention perform bulk updates of a search index for an information repository. In various embodiments of the invention, a batched set of update requests is run and a set of documents to be updated based on the set of requests is identified. One of a plurality of bulk update methods to use is selected based on an estimate of the cost of performing the bulk update. For example, a bulk update method based on updating only the indexes of the documents to be updated may be used instead of a bulk update method that involves re-indexing the full set of documents in the repository.

In embodiments, a method for updating a document search index having a plurality of index segments may comprise executing at least one update request comprising at least one transformation (an update request identifies a plurality of documents to be updated within the document index); identifying a set of matching index segments, within the document search index, that is associated with the plurality of documents to be updated; updating a first set of stored fields associated with the plurality of documents to be updated by applying at least one transformation to modify the first set of stored fields; generating a modified postings list for the document search index corresponding to the updated first set of stored fields; and updating a list of posting of the document search index based on the modified postings list. In embodiments, a bit vector may be maintained that identifies the plurality of documents to be updated within the document search index.

In embodiments, a set of postings and a second set of stored fields being associated with a document may be represented by a set of multiple indexes within the document search index, the second set of stored fields being a subset of the first set of stored fields. In embodiments, at least one of the multiple indexes within the set of multiple indexes may comprise an immutable stored field.

In embodiments, updating a first set of stored fields may comprise generating an inverted index of transformations associated with the plurality of documents to be updated; and updating a second set of stored fields of a document. In embodiments, updating a second set of stored fields of a document may comprise copying an unmodified stored field into a new index segment; or updating a modified stored field by applying at least one transformation to the modified stored field and writing the modified stored field into the new index segment.

In embodiments, generating a modified postings list may comprise creating an inverted index of modified postings associated with the plurality of documents to be updated. In embodiments, updating the list of postings may comprise copying a posting into a new index segment in response to the posting not being on the modified postings list; or writing a modified posting into the new index segment in response to the modified posting being on the modified postings list.

In embodiments, a method for identifying a bulk update for a document search index having a plurality of index segments may comprise identifying a plurality of documents to be updated, within the document search index, based on at least one update request comprising at least one transformation; identifying a first set of matching index segments associated with the plurality of documents to be updated; determining a first processing cost for updating the document search index associated with the plurality of documents to be updated; determining a second processing cost for updating the document search index associated with the first set of matching index segments; and selecting the bulk update for updating the document search index at least partially based on a relative comparison of the first processing cost to the second processing cost. In embodiments, the first processing cost may be related to an amount of computer resources required to update the document search index with complete index data from the documents to be updated; and the second processing cost may be related to an amount of computer resources required to update the document search index with index data from the first set of matching index segments.

In embodiments, a system for applying a set of update requests to a document search index having a plurality of index segments may comprise a matching document identifier that identifies a plurality of documents to be updated within the document search index; and an update method selector that selects a bulk update for the document search index; and an index updater that applies the selected bulk update to the document search index. In embodiments, an index updater may comprise a stored fields updated that updates a set of stored fields associated with the plurality of documents to be updated; and a postings updater that updates a list of postings of the document search index. In embodiments, the index updater may further comprise a transformation indexer that generates an inverted index of transformations associated with the plurality of documents to be updated.

Some features and advantages of the invention have been generally described in this summary section; however, additional features, advantages, and embodiments are presented herein or will be apparent to one of ordinary skill in the art in view of the drawings, specification, and claims hereof. Accordingly, it should be understood that the scope of the invention shall not be limited by the particular embodiments disclosed in this summary section.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 illustrates an example of components of a search index according to various embodiments of the invention.

FIG. 2 illustrates an example of writing components of a search index into segments according to various embodiments of the invention.

FIG. 3 illustrates an example of a multiple parallel index representation of a document within a search index according to various embodiments of the invention.

FIG. 4 illustrates an example of a multiple parallel index representation of an email document within a search index according to various embodiments of the invention.

FIG. 5A depicts a block diagram of a system for performing bulk updates of a search index according to various embodiments of the invention.

FIG. 5B depicts a block diagram of an index updater according to various embodiments of the invention.

FIG. 6 depicts a method for performing bulk updates of a search index according to various embodiments of the invention.

FIG. 7 depicts a method for updating a search index according to various embodiments of the invention.

FIG. 8 depicts a method for updating stored fields within a search index according to various embodiments of the invention.

FIG. 9 depicts a method for updating postings within a search index according to various embodiments of the invention.

FIG. 10 depicts a block diagram of a computing system according to various embodiments of the invention.

### DETAILED DESCRIPTION OF THE PREFERRED EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be performed in a variety of mediums, including software, hardware, or firmware, or a combination thereof. Accordingly, the flow charts described below are illustrative of specific embodiments of the invention and are meant to avoid obscuring the invention.

Components, or modules, shown in block diagrams are illustrative of exemplary embodiments of the invention and are meant to avoid obscuring the invention. It shall also be understood that throughout this discussion that components may be described as separate functional units, which may comprise sub-units, but those skilled in the art will recognize that the various components, or portions thereof, may be divided into separate components or may be integrated together, including integrated within a single system or component.

Furthermore, connections between components within the figures are not intended to be limited to direct connections. Rather, data between these components may be modified, re-formatted, or otherwise changed by intermediary components. Also, additional or fewer connections may be used. It shall also be noted that the terms “coupled” or “communicatively coupled” shall be understood to include direct connections, indirect connections through one or more intermediary devices, and wireless connections.

Reference in the specification to “one embodiment,” “preferred embodiment” or “an embodiment” means that a particular feature, structure, characteristic, or function described in connection with the embodiment is included in at least one embodiment of the invention. The appearances of the phrase “in one embodiment” in various places in the specification are not necessarily all referring to the same embodiment.

A. Structure of a Search Index

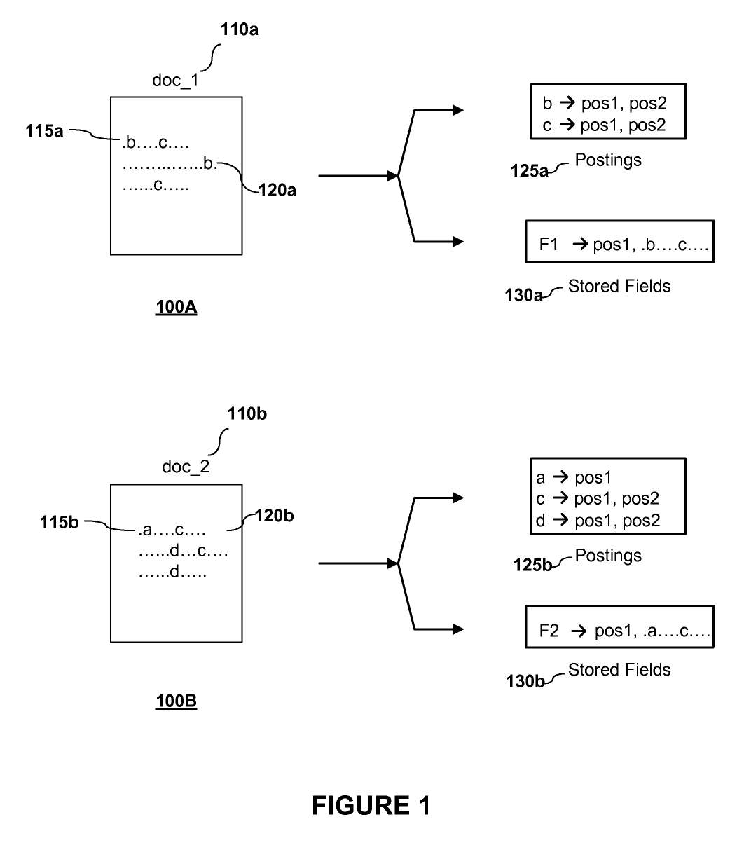

FIG. 1 illustrates exemplary search structures according to embodiments of the invention 100A and 100B illustrate representations of two documents in a document repository's search index. In this example, each document is assigned a unique identifier, (e.g. a document ID) 110a and 110b, and terms 120a and 120b within a document are indexed as postings 125a and 125b. A posting may comprise the term itself along with additional information, such as the document frequency (df) representing the number of documents within the repository in which the term occurs and, for each document containing the term, its document ID and term position(s) in the document. All of the postings created for all of the terms in the repository may be entered into a list kept within the search index. The postings in this list may be ordered and sorted in various ways, such as an alphabetical order of terms.

In various embodiments of the invention, the list of postings may be structured as an “inverted index” because it represents every term in a repository, in alphabetical order and sorted by document ID of documents in the repository that contain the term. An inverted index of postings is a major component of a search index that is used by an application for a quick retrieval of a set of documents in response to a search query. The result returned to the application also may include additional information about the terms from the postings. This kind of result may be used by an application that produces a summary or excerpt of the contents from each document in a retrieved set of documents.

A search index also may be used to store information about the content within documents in a repository. For example, a repository of email documents may include indexes of key fields within each email document (e.g. to:, from:, and cc:) as well as user-generated flags identifying a particular email(s) or document(s) of relevance. Referring to the example in FIG. 1, a key field in a document (115a and 115b) may be given a tag and be associated with content-related information such as the position of the key field within the document and the content within the key field. This type of search index entry is called a “stored field” (130a and 130b) and a set of these entries may be called a “forward index” because it may be used to resolve queries about the content in each document.

There is a variety of ways to represent a search index structure. For example, a search index may be represented as a binary tree (B-tree). A search index alternatively may be represented as a set of flat files that are in linked order. The flat files may be in a linear format, in a compressed format, or in a combination of the formats, and may be further organized into storage segments (hereinafter, “segments”). This type of search index representation is used by the Lucene search engine, for example.

A search index representation may be designed to enable fast access to improve the performance of executing requests or queries against the index. A search index representation also may be designed to maintain a compact size so that it does not require excessive computing resources when the search index is used for executing queries. A compact search index also reduces the cost of maintaining the index and also enables it to scale. Those skilled in the art will recognize that the choice of a search index representation is not critical to the present invention.

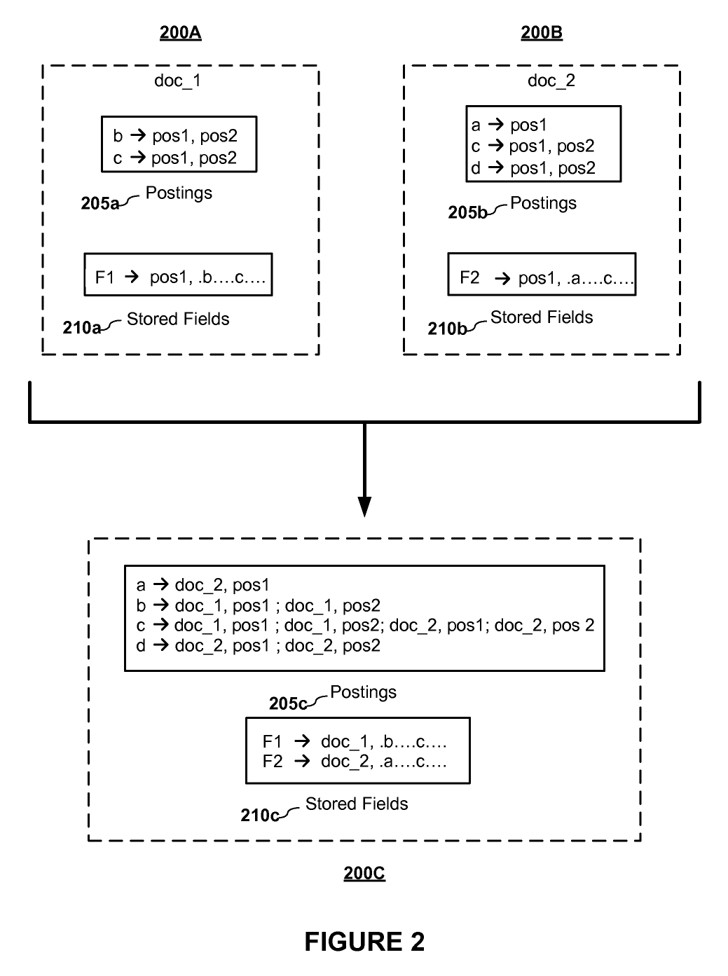

FIG. 2 illustrates the portion of a search index from FIG. 1 as it might be represented in flat files that are organized into segments according to various embodiments of the invention. The files containing the postings and stored fields of a document may be written to one segment. In this example, segments 200A and 200B contain postings (205a and 205b) and stored fields (210a and 210b) of a document. Files containing the postings and stored fields of a new document, being added to a search index, are written into a new separate segment. The files in the original existing segments are merged and written into a new single merged segment 200C, and the original segments are deleted. In this example, the number of segments containing the files representing the search index would stay the same after the addition of a new document (i.e. one new single segment and one new merged segment).

In various embodiments of the invention, files within merged segments may be merged with each other as the search index representation grows in size. Thus, the merged segments containing the oldest information are larger in size than the segments containing the newest information. The smaller size of segments containing the newest information (i.e. the files that have not yet been merged with existing files) enables new documents to be added quickly to the search index.

In various embodiments of the invention, the sizes of a set of search index segments may have a logarithmic size distribution, although those skilled in the art may recognize that various size distribution schemes exist and the choice of a particular size distribution scheme is not critical to the invention. Growth by merging existing data and writing the merged data into new segments may keep the overall size of a search index representation relatively small as new information is added, and may also allow a search index to scale to accommodate large repositories of documents. In embodiments, as illustrated in the example in FIG. 2, merging index data from two documents may be accomplished by merging the postings 205c and concatenating the stored fields 210c, and writing out the files containing the merged data into a new merged segment.

When documents are added or removed from a repository, or when content is modified, a search index should be updated to reflect the changes to the repository. Updating a search index may necessitate re-indexing all of the documents. This operation may be resource intensive since it involves re-analysis and re-writing all of the indexes. Some applications use repositories that change often, such as web search engines that use live data feeds. Those skilled in the art will recognize that having a search index update method that reduces the need for re-indexing all information in a repository is important for such applications.

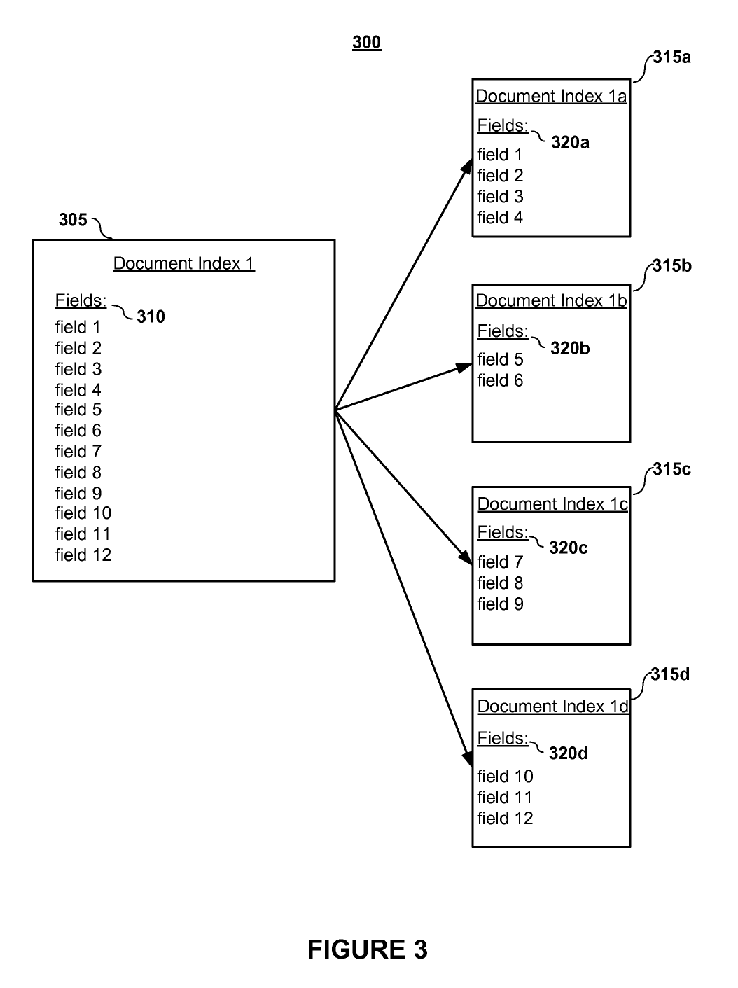

FIG. 3 illustrates an example of a document 305 with its content indexed into a set of twelve fields 310. In various embodiments of the invention, the set of fields may be divided across multiple indexes; each index containing a different subset of the fields. Referring to the example in FIG. 3, four subsets of the twelve fields 320a-d are distributed across four indexes 315a-d. A search index with this type of organization uses a “parallel indexing scheme,” and each index 315a-d is called a “subindex.” Those skilled in the art will recognize that a parallel indexing scheme may enable faster and more flexible querying of a search index because various combinations of fields can be associated across documents.

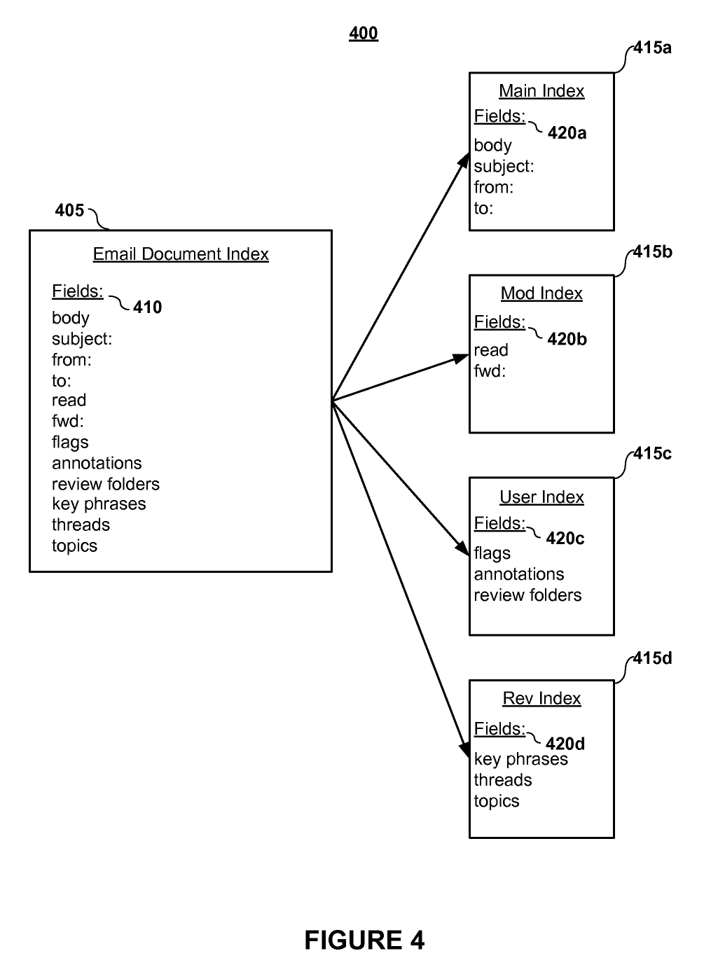

In various embodiments of the invention, the fields assigned to each subindex are grouped based upon criteria associated with the cost of updating a field. Two criteria that may be used are the size of a field (related to the cost of re-writing the field), and the likelihood that a field will change (i.e. whether the field is immutable). FIG. 4 illustrates an example of an email document 405 that is indexed into twelve fields 410 according to various embodiments of the invention. There are four subindexes 415a-d, each containing a different subset of the twelve fields. The fields in the Main Index 415a include the largest field (i.e. the body) and other immutable fields, such as the subject:, from:, and to: fields 420a. The Mod Index 415b contains fields that may change across duplicate copies of an email 420b. The User Index 415c contains fields that may change as a result of users accessing, designating, or describing an email, such as flags and annotations 420c. The Rev Index 415d contains fields that may change as a result of processing by an application such as assigning key phrases to the document or assigning the document to threads or topics 420d. In this example, an update to a flag in the User Index 415c for all documents in the repository may require re-writing only that index in a search index update, thus avoiding the cost of re-writing the larger unchanged fields in the Main Index 415a.

A search index that uses a parallel indexing scheme and is represented as flat files organized into segments may have an organization in which each subindex is written into a different segment. In various embodiments, the subindexes representing a single document may include the document ID of the document, creating an index of a document's content that is distributed across multiple segments. This type of representation enables applications to perform parallel reads and parallel writes to the search index, and those skilled in the art will recognize that multiple methods exist for performing these operations.

Segments containing subindexes may be organized so that the subindexes with smaller, mutable fields are written into different segments than the subindexes with larger, immutable fields. This type of organization enables a search index update method to avoid the cost of having to re-write all segments representing the entire search index during each update because the segments containing the unchanged subindexes with the largest fields are not re-written.

In various embodiments, a search index that is organized and represented in a similar way to the example in FIG. 4 also may address the update issue of “D-Duplication,” in which there are many copies of a document that only differ from each other in the content of a few of the fields. Turning again to the example in FIG. 4, there may be many copies of an email document 405 that differ in terms of the value of a thread assignment in the Rev Index 415d. It may be possible to update the segments containing the Rev Index 415d for the email document copies that are updated without having to update all of the segments containing all fields for all copies of the document 405.

One specific application of the present invention is its use in updating a search index that represents the content in a large repository of documents. In embodiments, the present invention may be used to apply a “bulk update” (simultaneously apply a large number of updates) to a search index.

B. System Implementations

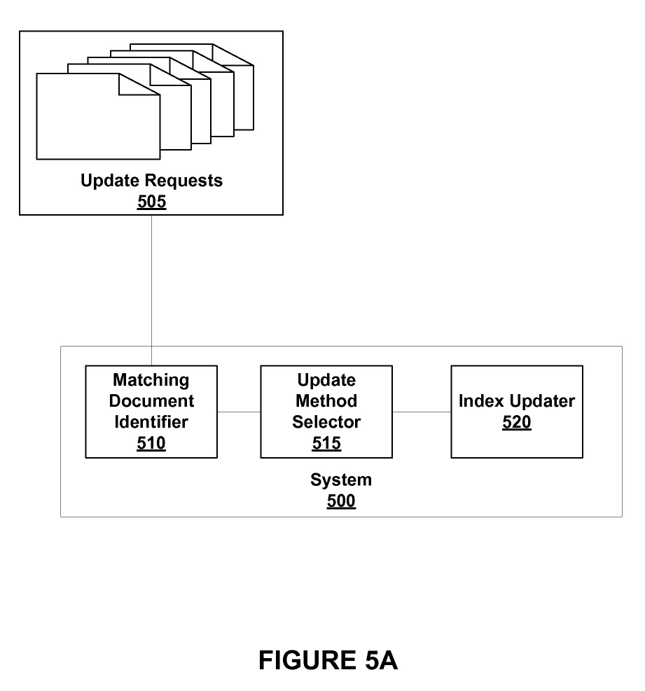

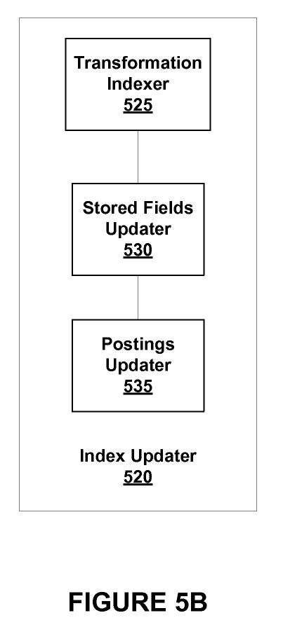

FIG. 5A depicts a system 500 for performing a bulk update of a search index according to various embodiments of the invention. System 500 comprises a matching document identifier 510, an update method selector 515, and an index updater 520.

In embodiments, matching document identifier 510 receives a batch (i.e. a set) of update requests 505, runs the batched requests, and stores the set of documents matching the requests. In embodiments, the document IDs of the documents matching the requests may be returned from running the batched requests. In various embodiments of the invention, a bit vector with a length equal to the number of documents in a repository may be created, and the position(s) corresponding to numerical value(s) of the document ID(s) of the set of documents matching the requests may be given a unique bit value.

The update method selector 515 receives the set of document identifiers matching the set of update requests and performs an analysis to select a preferred update method on the search index for the set of requests. In various embodiments of the invention, the search index representation may be a set of flat files that have been written into separate segments. In embodiments, the search index may be organized according to a parallel indexing scheme, although those skilled in the art will recognize that the search index may not be organized into multiple indexes, and that the indexing scheme is not critical to the invention.

Those skilled in the art will recognize that a typical update method for a search index is a “delete/add” method in which all document indexes are re-written and then the existing indexes are deleted and replaced with the new indexes. Applying a delete/add update method for one document index within a merged segment representing many document indexes may be expensive because many document indexes that were not updated must also be re-written. However, applying a delete/add update method for one document index within a segment containing only that document index may be fast and efficient. The update method selector 515 performs an analysis to estimate whether a delete/add update method is a preferred method to update the search index for the current set of update requests.

In various embodiments of the invention, a preferred update method is a method that would require the least amount of time to execute. One skilled in the art will recognize that the amount of time to execute an update method is correlated with the number of bytes within the search index that are changed during the execution of the update method. For example, the total number of bytes changed by a delete/add update method is proportional to the sum of the sizes of all documents being updated, while the total number of bytes changed by a bulk update method may be roughly equal to the total sizes of all index segments containing any fields of any documents being updated. In embodiments, a bulk update method may be preferred for a search index representation organized into multiple indexes for updates during which the fields being changed are small (tags, for example) while the documents themselves are large.

In various embodiments of the invention, the expected execution time of an update method may be approximated by an analysis comprising the number of documents to be updated, the sizes of the documents to be updated, the sizes of the fields to be updated, and the sizes of the segments to be updated. The set of update requests and the set of document identifiers may be used to find the segments that need to be updated by finding the matching segments that contain both the fields to be modified and the document identifiers.

In embodiments, an analysis may be applied to select whether a delete/add update method or bulk update method will be used to execute a particular update request. The sizes of the segments in the set of matching segments are summed, and the sum of the matching segment sizes may be compared to the total size of all the segments containing the identifiers of documents to be re-indexed in a delete/add update.

In embodiments, the bulk update method may be selected instead of a delete/add method if either

a) The total number of documents being updated is greater than a fixed percentage of the total number of documents in all segments containing any document to be updated; or

b) The total size of all body fields of documents being updated is greater than a fixed percentage of the total size of the segments containing those body fields (and the body fields of all other documents in those segments).

Those skilled in the art will recognize that body fields are the main text of a document (an email document, for example), and that the body field represents the bulk of the content. In various embodiments of the invention, the fixed percentage is a configuration parameter that typically has a small value such as 0.1%.

The index updater 520 receives a set of update requests and a set of matching documents, and performs a bulk update of the search index specified by the set of update requests. In various embodiments of the invention, index updater 520 may comprise a delete/add update method. Those skilled in the art will recognize that various delete/add update methods exist and that the selection of a particular delete/add update method is not critical to the invention.

FIG. 5B depicts an index updater 520, according to various embodiments of the invention, that comprises a transformation indexer 525, a stored fields updater 530, and a postings updater 535.

The transformation indexer 525 receives a set of update requests and a set of matching documents and builds an inverted index of transformations to be performed per document in the set of matching documents. In various embodiments of the invention, an update request may comprise a document ID, a set of fields to be updated, and a set comprising at least one transformation to be applied to the set of fields. A transformation is defined as a function that modifies the set of fields, and a transformation may specify adding, deleting, or modifying a field or a field value. In various embodiments of the invention, when a set of two or more transformations is compiled for a set of fields, the set of transformations may be ordered to reflect the order in which the transformations are applied.

The stored fields updater 530 receives an inverted index of transformations and a set of matching segments and updates the stored fields by applying the specified transformations and then re-writing the segments containing the updated stored fields. Documents within a segment that are not being updated may be bulk copied to the new segment. A posting comprising modified fields may be created for each updated document, and that posting may be added incrementally to a changed document postings data structure that is created and maintained in memory. The data structure may also contain information about additions and deletions of changed documents. Those skilled in the art will understand that various data structures may be used within the scope and spirit of the present invention.

The postings updater 535 receives a changed document postings data structure and a set of matching segments and updates the search index postings by re-writing the segments containing documents with postings that have been updated. In various embodiments of the invention, documents within a segment that do not contain updated postings may be bulk copied to the new segment.

C. Methods for Performing Bulk Updates of a Search Index

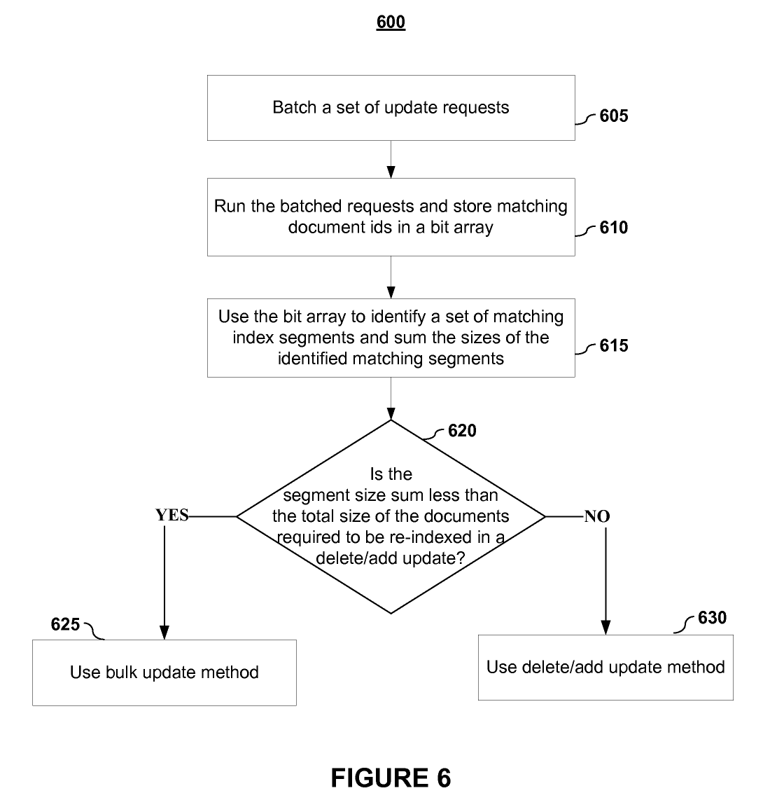

FIG. 6 depicts a method, independent of structure, for performing bulk updates of a search index according to various embodiments of the invention. Method 600 may be implemented by embodiments of system 500.

In various embodiments of the invention, a batch (i.e. a set) of update requests or queries is received 605. Those skilled in the art recognize that it is generally more efficient for search engines to update search indexes using batches of requests because the cost of performing an update typically depends upon the size of the search index representation rather than upon the number of update requests. The batched requests are run and the corresponding set of documents matching the requests is stored 610. In embodiments, the document IDs of the documents matching the requests are returned from running the batched requests. In certain embodiments, a bit vector with a length equal to the number of documents in a repository is created, and the position(s) corresponding to numerical value(s) of the document ID(s) of the documents matching the requests are given a unique bit value.

The set of update requests and the set of document identifiers are used to find the segments to be updated by identifying the matching segments that contain both the fields to be modified and the document identifiers. The sizes of the segments in the set of matching segments are summed 615 so that a comparison is performed relative to the total size of the segments containing the document indexes to be re-indexed in the delete/add update 620. This comparison may be based on an approximation of the execution time of an update method based on the number of bytes changed as previously discussed. The bulk update method is selected if either the number of updated documents is large compared to the number of documents in affected segments, or if the body fields of the documents being updated are large compared to the total size of body fields of all documents in affected segments 625. Otherwise, a delete/add method is selected 630.

1. Updating a Search Index

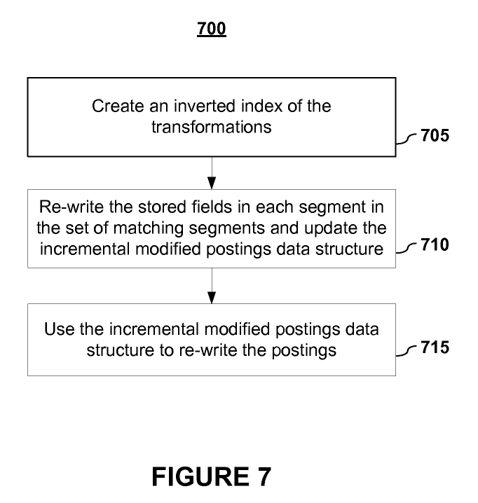

FIG. 7 depicts a method, independent of structure, for updating a search index according to various embodiments of the invention. Method 700 comprises the steps of creating an inverted index of the transformations 705; re-writing the stored fields in each segment comprising changed documents and updating an incremental modified postings data structure 710; and using the incremental modified postings data structure to re-write the postings 715. In various embodiments, method 700 may be implemented as step 625 in method 600, and in embodiments of index updater 520.

The set of update requests and the set of matching documents may be used to build an inverted index of transformations to be performed per document in the set of matching documents 705. In various embodiments of the invention, an update request may comprise a document ID, a set of fields to be updated, and a set comprising at least one transformation to be applied to the set of fields. Those skilled in the art will recognize that a transformation may be a function that may modify the set of fields, and a transformation may specify adding, deleting, or modifying a field or a field value. If a set of two or more transformations is compiled for a set of fields, the set of transformations may be ordered to reflect the order in which the transformations are applied.

a) Updating Stored Fields

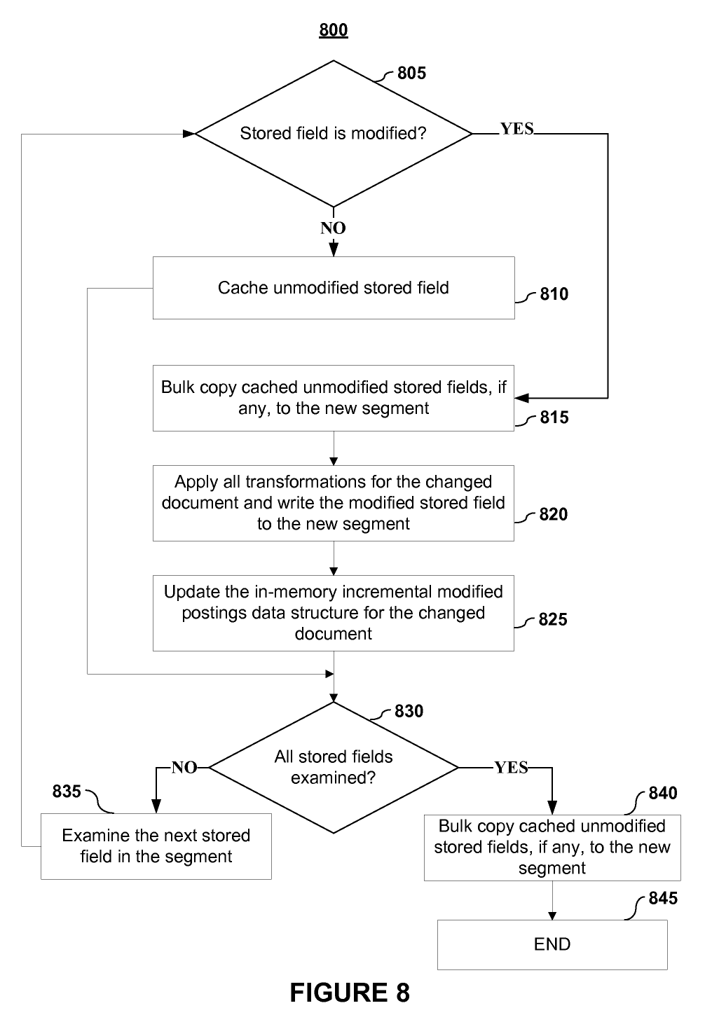

FIG. 8 depicts a method, independent of structure, for updating stored fields in a search index according to various embodiments of the invention. Method 800 may be implemented as step 710 of method 700, and in embodiments of stored fields updater 530.

The inverted index of transformations is used to identify which stored fields of which documents need to be modified. The stored fields in each matching segment are examined (830, 835), and the fields are written to a new segment 845. Stored fields of documents that are not identified in the inverted index as having modified stored fields 805 may be bulk copied to the new segment (815, 840). In various embodiments of the invention, stored fields to be bulk copied may be cached 815 so that copying all of the cached documents may occur in one operation. Those skilled in the art will recognize that other methods for bulk copying exist, and that selection of a particular method is not critical to the invention. If a stored field is to be modified, the associated list of transformations may be applied to the stored field, and then the modified stored field may be written to the new segment 820.

In various embodiments of the invention, a posting comprising modified fields may be created for each updated document, and that posting may be added incrementally to a changed document postings data structure 825 that may be created and maintained in memory for accessibility. In embodiments, the data structure may contain information about additions and deletions of changed documents. Those skilled in the art may recognize that the selections of the representation and storage location of the changed document postings data structure are not critical to the invention.

b) Updating Postings

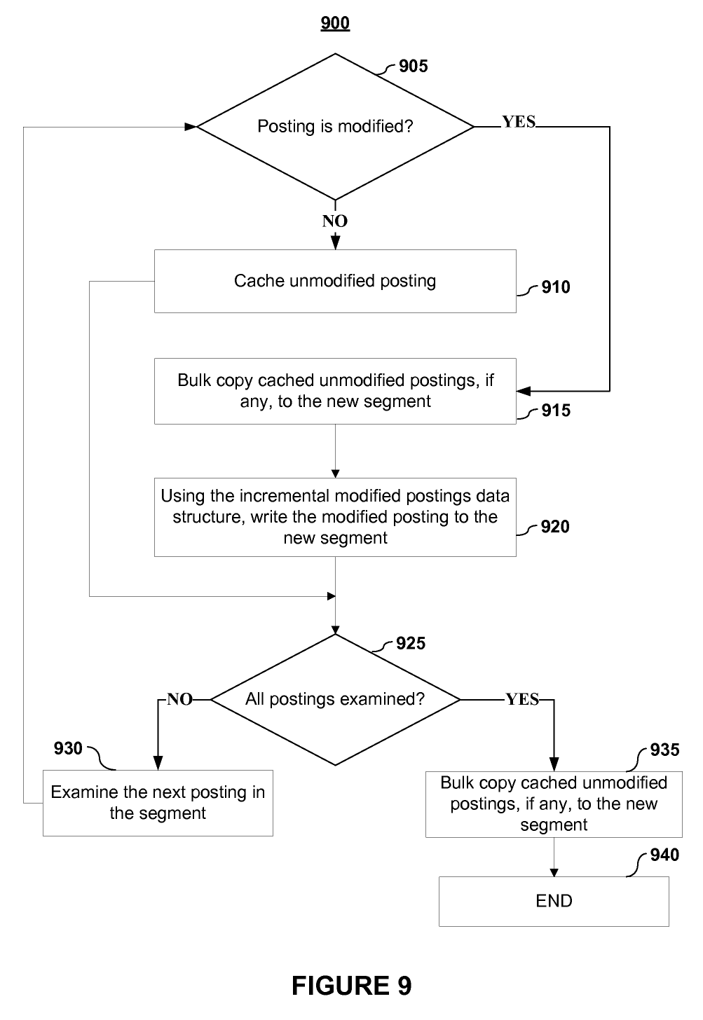

FIG. 9 depicts a method, independent of structure, for updating postings in a search index according to various embodiments of the invention. Method 900 may be implemented as step 715 of method 700, and in embodiments of postings updater 535.

The changed document postings data structure may be used to identify which postings of which documents need to be modified. The postings in each matching segment are examined (915, 935), and the postings are written to a new segment. Postings of documents that are not identified in the changed document postings data structure as having modified postings 905 may be bulk copied to the new segment (915, 935). In various embodiments of the invention, postings to be bulk copied may be cached 910 so that copying all of the cached postings may occur in one operation. Those skilled in the art will recognize that other methods for bulk copying exist, and that selection of a particular method is not critical to the invention. If a posting is modified, the modified posting may be written to the new segment 920.

D. Computing System Implementations

It shall be noted that the present invention may be implemented in any instruction-execution/computing device or system capable of processing data, including without limitation, a general-purpose computer and a specific computer, such as one intended for data processing. The present invention may also be implemented into other computing devices and systems. Furthermore, aspects of the present invention may be implemented in a wide variety of ways including software, hardware, firmware, or combinations thereof. For example, the functions to practice various aspects of the present invention may be performed by components that are implemented in a wide variety of ways including discrete logic components, one or more application specific integrated circuits (ASICs), and/or program-controlled processors. It shall be noted that the manner in which these items are implemented is not critical to the present invention.

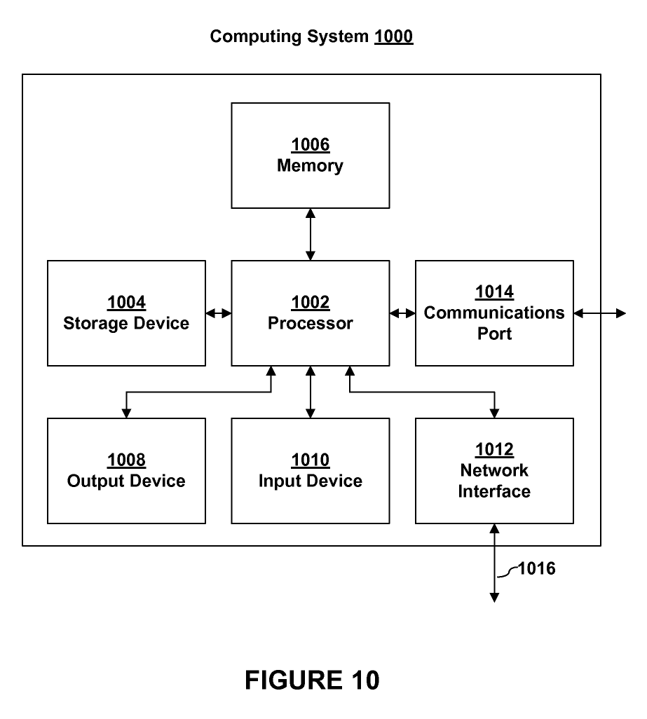

FIG. 10 depicts a functional block diagram of an embodiment of an instruction-execution/computing device 1000 that may implement or embody embodiments of the present invention. As illustrated in FIG. 10, a processor 1002 executes software instructions and interacts with other system components. In an embodiment, processor 1002 may be a general purpose processor such as an AMD processor, an INTEL x86 processor, a SUN MICROSYSTEMS SPARC, or a POWERPC compatible-CPU, or the processor may be an application specific processor or processors. A storage device 1004, coupled to processor 1002, provides long-term storage of data and software programs. Storage device 1004 may be a hard disk drive and/or another device capable of storing data, such as a computer-readable media (e.g., diskettes, tapes, compact disk, DVD, and the like) drive or a solid-state memory device. Storage device 1004 may hold programs, instructions, and/or data for use with processor 1002. In an embodiment, programs or instructions stored on or loaded from storage device 1004 may be loaded into memory 1006 and executed by processor 1002. In an embodiment, storage device 1004 holds programs or instructions for implementing an operating system on processor 1002. In one embodiment, possible operating systems include, but are not limited to, UNIX, AIX, LINUX, Microsoft Windows, and the Apple MAC OS. In embodiments, the operating system executes on, and controls the operation of, the computing system 1000.

An addressable memory 1006, coupled to processor 1002, may be used to store data and software instructions to be executed by processor 1002. Memory 1006 may be, for example, firmware, read only memory (ROM), flash memory, non-volatile random access memory (NVRAM), random access memory (RAM), or any combination thereof. In one embodiment, memory 1006 stores a number of software objects, otherwise known as services, utilities, components, or modules. One skilled in the art will also recognize that storage 1004 and memory 1006 may be the same items and function in both capacities. In an embodiment, one or more of the components of FIGS. 5A and 5B may be modules stored in memory 1004, 1006 and executed by processor 1002.

In an embodiment, computing system 1000 provides the ability to communicate with other devices, other networks, or both. Computing system 1000 may include one or more network interfaces or adapters 1012, 1014 to communicatively couple computing system 1000 to other networks and devices. For example, computing system 1000 may include a network interface 1012, a communications port 1014, or both, each of which are communicatively coupled to processor 1002, and which may be used to couple computing system 1000 to other computer systems, networks, and devices.

In an embodiment, computing system 1000 may include one or more output devices 1008, coupled to processor 1002, to facilitate displaying graphics and text. Output devices 1008 may include, but are not limited to, a display, LCD screen, CRT monitor, printer, touch screen, or other device for displaying information. Computing system 1000 may also include a graphics adapter (not shown) to assist in displaying information or images on output device 1008.

One or more input devices 1010, coupled to processor 1002, may be used to facilitate user input. Input device 1010 may include, but are not limited to, a pointing device, such as a mouse, trackball, or touchpad, and may also include a keyboard or keypad to input data or instructions into computing system 1000.

In an embodiment, computing system 1000 may receive input, whether through communications port 1014, network interface 1012, stored data in memory 1004/1006, or through an input device 1010, from a scanner, copier, facsimile machine, or other computing device.

One skilled in the art will recognize no computing system is critical to the practice of the present invention. One skilled in the art will also recognize that a number of the elements described above may be physically and/or functionally separated into sub-modules or combined together.

It shall be noted that embodiments of the present invention may further relate to computer products with a computer-readable medium that have computer code thereon for performing various computer-implemented operations. The media and computer code may be those specially designed and constructed for the purposes of the present invention, or they may be of the kind known or available to those having skill in the relevant arts. Examples of computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter.

While the invention is susceptible to various modifications and alternative forms, specific examples thereof have been shown in the drawings and are herein described in detail. It should be understood, however, that the invention is not to be limited to the particular forms disclosed, but to the contrary, the invention is to cover all modifications, equivalents, and alternatives falling within the scope of the appended claims.

What is claimed is:

1. A method for updating a document search index having a plurality of index segments, the method comprising:
executing at least one update request comprising at least one transformation, the at least one update request identifying a plurality of documents to be updated within the document index;
identifying a set of matching index segments, within the document search index, associated with the plurality of documents to be updated;
updating a first set of stored fields associated with the plurality of documents to be updated by applying the at least one transformation to modify the first set of stored fields;
generating a modified postings list for the document search index corresponding to the updated first set of stored fields; and
updating a list of postings of the document search index based on the modified postings list.

2. The method of claim 1 wherein:
a set of postings and a second set of stored fields being associated with a document are represented by a set of multiple indexes within the document search index; and
the second set of stored fields is a subset of the first set of stored fields.

3. The method of claim 2 wherein at least one of the multiple indexes, within the set of multiple indexes, comprises an immutable stored field.

4. The method of claim 1 wherein the step of updating a first set of stored fields comprises:
generating an inverted index of transformations associated with the plurality of documents to be updated; and
updating a second set of stored fields of a document, within the plurality of documents, by:
copying an unmodified stored field, within the second set of stored fields, into a new index segment; and
updating a modified stored field, within the second set of stored fields, by applying at least one transformation to the modified stored field and writing the modified stored field into the new index segment.

5. The method of claim 1 wherein the step of generating a modified postings list comprises creating an inverted index of modified postings associated with the plurality of documents to be updated.

6. The method of claim 1 wherein the step of updating the list of postings comprises:
copying a posting into a new index segment in response to the posting not being on the modified postings list; and
writing a modified posting into the new index segment in response to the modified posting being on the modified postings list.

7. The method of claim 1 wherein a bit vector is maintained that identifies the plurality of documents to be updated within the document search index.

8. A computer readable medium having instructions for performing the method of claim 1.

9. A method for identifying a bulk update for a document search index having a plurality of index segments, the method comprising:
identifying a plurality of documents to be updated, within the document search index, based on at least one update request comprising at least one transformation;
identifying a first set of matching index segments, within the plurality of index segments, associated with the plurality of documents to be updated;
determining a first processing cost for updating the document search index associated with the plurality of documents to be updated;
determining a second processing cost for updating the document search index associated with the first set of matching index segments; and
selecting the bulk update for updating the document search index, the selected bulk update being at least partially based on a relative comparison of the first processing cost to the second processing cost.

10. The method of claim 9 wherein the first processing cost relates to an amount of computer resources required to update the document search index with complete index data from the documents to be updated.

11. The method of claim 9 wherein the second processing cost relates to an amount of computer resources required to update the document search index with index data from the first set of matching index segments.

12. The method of claim 11 wherein the index data from the first set of matching index segments is updated responsive to the second processing cost being less than the first processing cost.

13. The method of claim 12 further comprising the steps of:
updating a first set of stored fields associated with the first set of matching index segments by applying the at least one transformation;
generating a modified postings list for the document search index corresponding to the updated first set of stored fields; and
updating a list of postings of the document search index based on the modified postings list.

14. The method of claim 13 wherein:
a set of postings and a second set of stored fields being associated with a document are represented by a set of multiple indexes within the document search index; and
the second set of stored fields is a subset of the first set of stored fields.

15. The method of claim 14 wherein at least one of the multiple indexes, within the set of multiple indexes, comprises an immutable stored field.

16. The method of claim 13 wherein the step of updating a first set of stored fields comprises:
generating an inverted index of transformations associated with the plurality of documents to be updated; and
updating a second set of stored fields of a document, within the plurality of documents, by performing a method of steps comprising:
copying an unmodified stored field, within the second set of stored fields, into a new index segment; and
updating a modified stored field, within the second set of stored fields, by applying at least one transformation to the modified stored field and writing the modified stored field into the new index segment.

17. The method of claim 13 wherein the step of updating the list of postings comprises:
copying a posting into a new index segment in response to the posting not being on the modified postings list; and
writing a modified posting into the new index segment in response to the modified posting being on the modified postings list.

18. A computer readable medium having instructions for performing the method of claim 9.

19. A system for applying a set of update requests to a document search index having a plurality of index segments, the system comprising:
a matching document identifier, coupled to receive the set of update requests, that identifies a plurality of documents to be updated within the document search index;
an update method selector, coupled to receive the plurality of documents to be updated, that selects a bulk update for the document search index by performing a method comprising the steps of:
identifying a first set of matching index segments, within the plurality of index segments, associated with the plurality of documents to be updated;
determining a first processing cost for updating the document search index associated with the plurality of documents to be updated;
determining a second processing cost for updating the document search index associated with the first set of matching index segments; and
selecting the bulk update for updating the document search index, the selected bulk update being at least partially based on a relative comparison of the first processing cost to the second processing cost; and
an index updater that applies the selected bulk update to the document search index.

20. The system of claim 19 wherein a bit vector is maintained that identifies the plurality of documents to be updated.

21. The system of claim 19 wherein index updater performs the steps of:
updating a first set of stored fields associated with the first set of matching index segments by applying the at least one transformation;
generating a modified postings list for the document search index corresponding to the updated first set of stored fields; and
updating a list of postings of the document search index based on the modified postings list.

22. The system of claim 21 wherein:
a set of postings and a second set of stored fields being associated with a document are represented by a set of multiple indexes within the document search index; and
the second set of stored fields is a subset of the first set of stored fields.

23. The system of claim 21 wherein the step of updating a first set of stored fields comprises:
generating an inverted index of transformations associated with the plurality of documents to be updated; and
updating a second set of stored fields of a document, within the plurality of documents, by performing a method comprising the steps of:
copying an unmodified stored field, within the second set of stored fields, into a new index segment; and
updating a modified stored field, within the second set of stored fields, by applying at least one transformation to the modified stored field and writing the modified stored field into the new index segment.

24. An index updater that applies a set of update requests to a document search index having a plurality of index segments, the system comprising:
a stored fields updater, coupled to receive a plurality of documents to be updated and a set of matching index segments, the stored fields updater updates a set of stored fields associated with the plurality of documents to be updated; and
a postings updater, coupled to receive the updated set of stored fields, the postings updater updates a list of postings of the document search index by performing a method comprising the steps of:
generating a modified postings list for the document search index corresponding to the updated set of stored fields; and
updating the list of postings of the document search index at least partially based on the modified postings list.

25. The system of claim 24, the system further comprising a transformation indexer, coupled to receive the plurality of documents to be updated and the set of update requests comprising at least one transformation, the transformation indexer generates an inverted index of transformations associated with the plurality of documents to be updated.

26. The system of claim 24 wherein a set of postings and a set of stored fields associated with a document are represented by a set of multiple indexes within the document search index.

27. The system of claim 24 wherein updating a set of stored fields associated with the plurality of documents to be updated comprises:
generating an inverted index of transformations associated with the plurality of documents to be updated; and
updating a second set of stored fields of a document, within the plurality of documents, by performing a method comprising the steps of:
copying an unmodified stored field, within the second set of stored fields, into a new index segment; and
updating a modified stored field, within the second set of stored fields, by applying at least one transformation to the modified stored field and writing the modified stored field into the new index segment.

28. The system of claim 24 wherein generating a modified postings list comprises creating an inverted index of modified postings associated with the plurality of documents to be updated.

29. The system of claim 24 wherein updating the list of postings comprises:
copying a posting into a new index segment in response to the posting not being on the modified postings list; and
writing a modified posting into the new index segment in response to the modified posting being on the modified postings list.
